(19) United States
(12) Patent Application Publication
(10) Pub. No.: US 2003/0218692 A1
(43) Pub. Date: Nov. 27, 2003

(54) Video signal processing device

(75) Inventors: Kunihiro Kaida, Osaka (JP); Koso Takeuchi, Osaka (JP)

Correspondence Address: Jack Q. Lever, Jr., McDERMOTT, WILL & EMERY, 600 Thirteenth Street, N.W., Washington, DC, 20005-3096, US

(73) Assignee: MATSUSHITA ELECTRIC INDUSTRIAL CO., LTD.

(21) Appl. No.: 10/412,392

(22) Filed: Apr. 14, 2003

(30) Foreign Application Priority Data
May 27, 2002 (JP) 2002-152749

(51) Int. Cl. H04N 11/20

(52) U.S. Cl. 348/448; 348/458; 348/446

(57) ABSTRACT

A video signal processing device of the invention includes an IP conversion means for converting an interlaced video signal that has been input into a progressive video signal and outputting it, a synthesis means for synthesizing the progressive video signal and a sub-picture or OSD that has been input and outputting the result as a progressive video signal, and a PI conversion means for converting the progressive video signal into an interlaced video signal and outputting it. The progressive video signal and the interlaced video signal are both output. Thus, the picture quality of synthetic sub-pictures or OSDs is not deteriorated and the progressive video signal and the interlaced video signal can be output simultaneously.

### BACKGROUND OF THE INVENTION

The present invention relates to video signal processing devices that simultaneously output progressive video signals and interlaced video signals.

A conventionally known video signal processing device is shown in FIG. 7. This device synthesizes an interlaced video signal and a sub-picture according to the DVD standard (hereinafter referred to as “sub-picture”) or an on-screen display (hereinafter abbreviated as “OSD”), converts the interlaced video signal into a progressive video signal, and simultaneously outputs the progressive video signal and the interlaced video signal.

FIG. 7 is a diagram showing a conventional video signal processing device.

The video signal processing device shown in FIG. 7 has a terminal 101 for input of interlaced video signals, a terminal 102 for input of signals displaying a sub-picture or an OSD, a synthesis portion 103 for synthesizing the interlaced video signal that is input from the input terminal 101 and the signal displaying a sub-picture or an OSD that is input from the input terminal 102, an IP conversion portion 104 for converting the interlaced synthetic video signal that is output from the synthesis portion 103 into a progressive video signal, an output terminal 105 for outputting the progressive video signal from the IP conversion portion 104, and an output terminal 106 for outputting the synthetic video signal from the synthesis portion 103.

Next, the operation of the video signal processing device shown in FIG. 7 is described.

The synthesis portion 103 synthesizes the interlaced video signal that is input from the input terminal 101 and the interlaced signal displaying a sub-picture or an OSD that is input from the input terminal 102, and outputs the synthetic video signal. The synthetic video signal is output from the output terminal 106 as an interlaced video signal. The synthetic video signal that is output from the synthesis portion 103 is input to the IP conversion portion 104. The IP conversion portion 104 employs scan line interpolation to convert the interlaced synthetic video signal into a progressive video signal, and the progressive video signal is then output from the output terminal 105.

However, as mentioned above, the interlaced video signal is synthesized with the signal displaying a sub-picture or an OSD before it is converted to a progressive video signal, and thus scan line interpolation causes the sub-picture or OSD image to become blurred. Therefore, the quality of the video image is deteriorated.

Also, as mentioned above, the interlaced video image and the sub-picture are synthesized in the interlaced format. If synthesis is performed in the interlaced format and the display lines displaying the sub-picture are managed by the frame line numbers, then the line numbers must be converted to field line numbers. Consequently, the scale of the circuit becomes large.

Further, as mentioned above, if a plurality of field data are employed when the interlaced video signal is converted into a progressive video signal by the IP conversion portion 104, then delays that accompany conversion occur in field units. This causes a time difference between the output of the progressive video signal from the output terminal 105 and the output of the interlaced video signal from the output terminal 106.

### SUMMARY OF THE INVENTION

It is an object of the invention is provide a video signal processing device with which the picture quality is not deteriorated.

It is a further object of the invention to provide a video signal processing device with which the circuit scale does not become large.

It is yet a further object of the invention to provide a video signal processing device with which no time difference occurs between the output of a progressive-type video signal and an interlaced-type video signal.

More specifically, to achieve the above objects, a video signal processing device of the invention is provided with an IP conversion means for converting a first interlaced video signal, which has been input, into a first progressive video signal and outputting it, a synthesis means for synthesizing the first progressive video signal and a sub-video signal for displaying a sub-video that has been input and outputting the result as a second progressive video signal, and a PI conversion means for converting the second progressive video signal into a second interlaced video signal and outputting it, and the second progressive video signal and the second interlaced video signal are both output.

Therefore, after the interlaced video signal is converted into a progressive video signal it is synthesized with the sub-video. Thus, a deterioration of the picture quality can be prevented without the sub-video becoming blurred. Also, because the sub-video is synthesized to a progressive video signal, it is not necessary to convert the line numbers to field line numbers, which allows the circuit scale to be kept small.

In the video signal processing device of the invention, it is preferable that the sub-video signal that is synthesized by the synthesis means is a signal for displaying a sub-picture or an on-screen display.

In the video signal processing device of the invention, it is preferable that the IP conversion means interpolates scan lines from the first interlaced video signal so as to convert the first interlaced video signal into the first progressive video signal and outputs the first progressive video signal, and that the PI conversion means decimates the scan lines that have been interpolated by the IP conversion means so as to convert the second progressive video signal into the second interlaced video signal and outputs the second interlaced video signal.

In the video signal processing device of the invention, it is preferable that the IP conversion means interpolates scan lines from the first interlaced video signal so as to convert the first interlaced video signal into the first progressive video signal and outputs the first progressive video signal, and outputs to the PI conversion means a field identification signal that indicates whether the first progressive video signal has been interpolated from scan lines of an odd-numbered field or an even-numbered field of the first interlaced video signal, and that the PI conversion means decimates even-numbered scan lines of the second progressive video signal and converts these to the second interlaced video signal if from the field identification signal it is determined that the first progressive video signal has been interpolated from scan lines of an odd-numbered field of the first interlaced video signal, and decimates odd-numbered scan lines of the second progressive video signal and converts these to the second interlaced video signal if from the field identification signal it is determined that the first progressive video signal has been interpolated from scan lines of an even-numbered field of the first interlaced video signal.

To achieve the above objects, another video signal processing device of the invention is provided with an IP conversion means for converting a first interlaced video signal, which has been input, into a first progressive video signal and outputting it, a synthesis means for synthesizing the first progressive video signal and a sub-video signal for displaying a sub-video that has been input and outputting the result as a second progressive video signal, a PI conversion means for converting the second progressive video signal into a second interlaced video signal and outputting it, and a field signal generation means for outputting a field identification signal that indicates whether a field of the second interlaced video signal from the PI conversion means is an odd-numbered field or an even-numbered field, and the second progressive video signal and the second interlaced video signal are both output.

Therefore, after the interlaced video signal is converted into a progressive video signal it is synthesized with the sub-video. Thus, a deterioration of the picture quality can be prevented without the sub-video becoming blurred. Also, because the sub-video is synthesized to a progressive video signal, it is not necessary to convert the line numbers to field line numbers, which allows the circuit scale to be kept small.

In the video signal processing device of the invention, it is preferable that the sub-video signal that is synthesized by the synthesis means is a signal for displaying a sub-picture or an on-screen display.

In the video signal processing device of the invention, it is preferable that the IP conversion means interpolates scan lines from the first interlaced video signal so as to convert the first interlaced video signal into the first progressive video signal and outputs the first progressive video signal, and that the PI conversion means decimates the scan lines that have been interpolated by the IP conversion means so as to convert the second progressive video signal into the second interlaced video signal and outputs the second interlaced video signal.

In the video signal processing device of the invention, it is preferable that the IP conversion means, in a case where the field identification signal received from the field signal generation means indicates an odd-numbered field, interpolates scan lines from an odd-numbered field of the first interlaced video signal so as to convert the first interlaced video signal into the first progressive video signal and outputs the first progressive video signal, and in a case where the field identification signal received from the field signal generation means indicates an even-numbered field, interpolates scan lines from an even-numbered field of the first interlaced video signal so as to convert the first interlaced video signal into the first progressive video signal and outputs the first progressive video signal, and that the PI conversion means decimates even-numbered scan lines of the second progressive video signal and converts these to the second interlaced video signal if the field identification signal received from the field signal generation means indicates an odd-numbered field, and decimates odd-numbered scan lines of the second progressive video signal and converts these to the second interlaced video signal if the field identification signal received from the field signal generation means indicates an even-numbered field.

To solve the above problems, a yet further video signal processing device of the invention is provided with an IP conversion means for converting a first interlaced video signal, which has been input, into a first progressive video signal and outputting it, a synthesis means for synthesizing the first progressive video signal and a sub-video signal for displaying a sub-video that has been input and outputting the result as a second progressive video signal, a line memory for converting the second progressive video signal into the second interlaced video signal and outputting it, a progressive horizontal synchronizing pulse generation means for outputting a progressive horizontal synchronizing pulse signal based on a clock signal that is input, an interlaced horizontal synchronizing pulse generation means for outputting an interlaced horizontal synchronizing pulse signal based on the clock signal, a field signal generation means for outputting a field identification signal that indicates whether a field of the second interlaced video signal from the line memory is an odd-numbered field or an even-numbered field, based on the interlaced horizontal synchronizing pulse signal from the interlaced horizontal synchronizing pulse generation means, a write control means for outputting to the line memory a write control signal for controlling writing of the second progressive video signal to the line memory, based on the progressive horizontal synchronizing pulse signal from the progressive horizontal synchronizing pulse generation means and the field identification signal from the field signal generation means, and a read control means for outputting to the line memory a read control signal for controlling reading of the second interlaced video signal from the line memory, based on the interlaced horizontal synchronizing pulse signal from the interlaced horizontal synchronizing pulse generation means and the field identification signal from the field signal generation means, and the second progressive video signal that is output from the synthesis means and the second interlaced video signal that is read out from the line memory are both output.

Therefore, after the interlaced video signal is converted into a progressive video signal it is synthesized with the sub-video. Thus, a deterioration of the picture quality can be prevented without the sub-video becoming blurred. Also, because the sub-video is synthesized to a progressive video signal, it is not necessary to convert the line numbers to field line numbers, which allows the circuit scale to be kept small.

In the video signal processing device of the invention, it is preferable that the sub-video signal that is synthesized by the synthesis means is a signal for displaying a sub-picture or an on-screen display.

In the video signal processing device of the invention, it is preferable that the IP conversion means, in a case where the field identification signal received from the field signal generation means indicates an odd-numbered field, interpolates scan lines from an odd-numbered field of the first interlaced video signal so as to convert the first interlaced video signal into the first progressive video signal and outputs the first progressive video signal, and in a case where the field identification signal received from the field signal generation means indicates an even-numbered field, interpolates scan lines from an even-numbered field of the first interlaced video signal so as to convert the first interlaced video signal into the first progressive video signal and outputs the first progressive video signal; that the write control means outputs the write control signal for writing the odd-numbered scan lines of the second progressive video signal to the line memory if the field identification signal from the field signal generation means indicates an odd-numbered field, and outputs the write control signal for writing the even-numbered scan lines of the second progressive video signal to the line memory if the field identification signal from the field signal generation means indicates an even-numbered field; and that the read control means outputs the read control signal for reading, as the second interlaced video signal, scan lines of the second progressive video signal that have been written to the line memory according to the read control signal from the read control means.

### BRIEF DESCRIPTION OF THE DRAWINGS

FIG. 1 is a diagram showing an example of the configuration of the video signal processing device according to the first embodiment of the invention.

FIG. 2 is a diagram for illustrating an example of conversion by the IP conversion portion.

FIG. 3 is a diagram for illustrating an example of conversion by the PI conversion portion.

FIG. 4 is a diagram showing an example of the configuration of the video signal processing device according to the second embodiment of the invention.

FIG. 5 is a diagram showing an example of the configuration of the video signal processing device according to the third embodiment of the invention.

FIG. 6 is a diagram for illustrating an example of PI conversion using the line memory, the write control portion, and the read control portion.

FIG. 7 is a diagram showing an example of the configuration of a conventional video signal processing device.

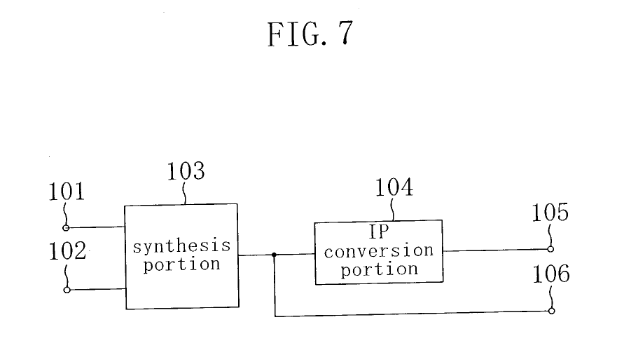

### DETAILED DESCRIPTION OF THE INVENTION

Hereinafter, embodiments of the invention are described with reference to the drawings.

First Embodiment

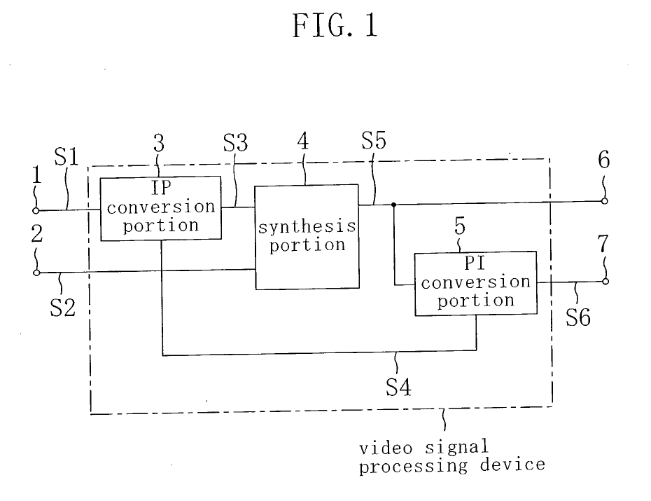

FIG. 1 is a diagram showing a configuration example of the video signal processing device according to the first embodiment of the invention.

The video signal processing device shown in FIG. 1 has an input terminal 1, an input terminal 2, an IP conversion portion 3 (corresponds to the IP conversion means), a synthesis portion 4 (corresponds to the synthesis means), a PI conversion portion 5 (corresponds to the PI conversion means), an output terminal 6, and an output terminal 7.

The input terminal 1 is for input of an interlaced video signal S1 (corresponds to the first interlaced video signal).

The input terminal 2 is for input of a signal S2 (corresponds to the sub-video signal) for displaying a sub-picture according to the DVD standard (hereinafter referred to as “sub-picture”) or an on-screen display (hereinafter abbreviated as “OSD”).

The IP conversion portion 3 converts the interlaced video signal S1 from the input terminal 1 into a progressive video signal S3 (corresponds to the first progressive video signal) using scan line interpolation, and outputs this signal. Moreover, the IP conversion portion 3 uses an internally provided identification portion 3a (not shown) to identify whether the progressive video signal S3 that is output is based on an interface video signal S1 on which scan line interpolation has been performed for the odd-numbered field or for the even-numbered field, and outputs to the PI conversion portion 5 an even/odd field identification signal S4 (corresponds to the field identification signal) indicating which of these fields have been subjected to scan line interpolation.

The synthesis portion 4 synthesizes the progressive video signal S3 that is output from the IP conversion portion 3 and the signal S2 displaying a sub-picture or an OSD from the input terminal 2, and outputs a progressive synthetic video signal S5 (corresponds to the second progressive video signal).

The PI conversion portion 5 converts the progressive synthetic video signal S5 from the synthesis portion 4 into an interlaced video signal S6 (corresponds to the second interlaced video signal) based on the even/odd field identification signal S4 that is input from the IP conversion portion 3.

The output terminal 6 outputs the progressive synthetic video signal S5 from the synthesis portion 4.

The output terminal 7 outputs the interlaced video signal S6 from the PI conversion portion 5.

Next, the operation of the video signal processing device according to this embodiment and configured as above is described.

The interlaced video signal S1 that is input from the input terminal 1 is converted into the progressive video signal S3 by the IP conversion portion 3 through scan line interpolation (described in detail later). Then, the synthesis portion 4 synthesizes the progressive video signal S3 and the signal S2 displaying a sub-picture or an OSD from the input terminal 2, and outputs the synthetic video signal S5. The synthetic video signal S5 from the synthesis portion 4 is output from the output terminal 6. Also, the progressive synthetic video signal S5 from the synthesis portion 4 is converted to the interlaced video signal S6 by the PI conversion portion 5 (explained in detail later), and is output from the output terminal 7.

The specific operation of the IP conversion portion 3 is described next.

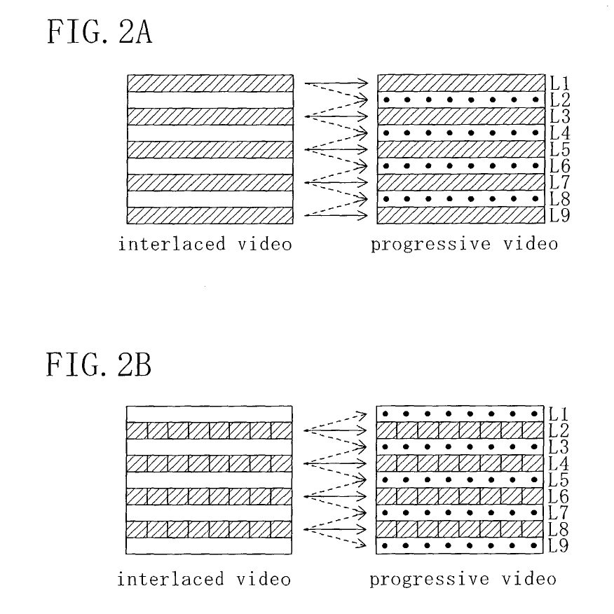

FIG. 2 is a diagram for illustrating an example of conversion from the interlaced video signal S1 to the progressive video signal S3.

FIG. 2A is a diagram for describing an example of conversion in which the interlaced video signal S1 that is input to the IP conversion portion 3 is an odd-numbered field. FIG. 2B is a diagram for describing an example of conversion in which the interlaced video signal S1 that is input to the IP conversion portion 3 is an even-numbered field.

As shown in FIG. 2A, if the interlaced video signal S1 that is input is an odd-numbered field, then the IP conversion portion 3 outputs the interlaced video signal S1 as the odd-numbered scan lines of the progressive video signal S3. At this time, the IP conversion portion 3 outputs the interlaced video signal S1 as the odd-numbered scan lines of the progressive video signal S3 at twice the speed at which the interlaced video signal S1 is input. Also, the even-numbered scan lines of the progressive video signal S3 are interpolated from the scan lines before and after the lines of the interlaced video signal S1, and are output. Moreover, in this case, the IP conversion portion 3 outputs an L-level even/odd field identification signal S4.

On the other hand, as shown in FIG. 2B, if the interlaced video signal S1 that is input is an even-numbered field, then the IP conversion portion 3 outputs the interlaced video signal S1 as the even-numbered scan lines of the progressive video signal S3. At this time, the IP conversion portion 3 outputs the interlaced video signal S1 as the even-numbered scan lines of the progressive video signal S3 at twice the speed at which the interlaced video signal S1 is input. Also, the odd-numbered scan lines of the progressive video signal S3 are interpolated from the scan lines before and after the lines of the interlaced video signal S1, and are output. Moreover, in this case, the IP conversion portion 3 outputs an H-level even/odd field identification signal S4.

It should be noted that the method for scan line interpolation that has been described is a method of interpolation using the two lines before and after the scanned lines, however, there are no limitations to this.

Next, the specific operation of the PI conversion portion 5 is described.

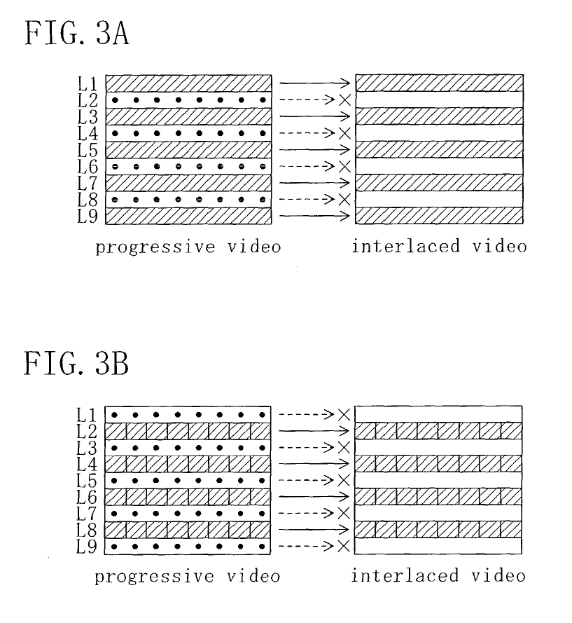

FIG. 3 is a diagram for explaining examples of conversion from the progressive synthetic video signal S5 to the interlaced video signal S6.

FIG. 3A is a diagram for illustrating an example of conversion when the even/odd identification signal S4 that is input to the PI conversion portion 5 is L-level, and FIG. 3B is a diagram for illustrating an example of conversion when the even/odd field identification signal S4 that is input to the PI conversion portion 5 is H-level.

As shown in FIG. 3A, if the even/odd field identification signal S4 is L-level, then the PI conversion portion 5 outputs the odd-numbered scan lines of the progressive synthetic video signal S5 that has been input to serve as the interlaced video signal S6, and does not output the even-numbered scan lines. Also, the output of the odd-numbered scan lines is made at half the speed at which the synthetic video signal S5 is input to the PI conversion portion 5.

As shown in FIG. 3B, if the even/odd field identification signal S4 is H-level, then the PI conversion portion 5 outputs the even-numbered scan lines of the progressive synthetic video signal S5 that has been input to serve as the interlaced video signal S6, and does not output the odd-numbered scan lines. Also, the output of the even-numbered scan lines is made at half the speed at which the synthetic video signal S5 is input to the PI conversion portion 5.

Thus, depending on whether the even/odd field identification signal S4 is L-level or H-level, by decimating either the even-numbered or the odd-numbered lines of the respective progressive synthetic video signal S5, the interlaced video signal S6 that is output from the PI conversion portion 5 becomes a signal equivalent to the interlaced video signal S1 that is input to the input terminal 1.

Also, because the PI conversion portion 5 outputs half the number of the scan lines of the progressive synthetic video signal S5 that is input at half the speed at which the progressive synthetic video signal S5 that is input and the interlaced video signal S6 that is output. To put it differently, no time difference occurs between the progressive synthetic video signal S5 that is output from the output terminal 6 and the interlaced video signal S6 that is output from the output terminal 7.

It should be noted that in the example described above, a sub-picture or an OSD serves as the video that is synthesized to the first progressive video signal S3, however, the present invention is not limited to this, and the invention can be similarly embodied even if a video used as a sub-video is displayed.

As described above, the video signal processing device according to the first embodiment of the invention synthesizes the interlaced video signal S1 that is input and the signal S2 that displays a sub-picture or an OSD after the interlaced video signal S1 has been converted to the progressive video signal S3. For this reason, the progressive synthetic video signal S5 that is output from the output terminal 6 does not exhibit a blurred sub-picture or OSD image due to scan line interpolation, which allows the picture quality to be kept from deteriorating.

Also, because the sub-picture is synthesized to the progressive video signal S3, it is no longer necessary to convert the display lines displaying the sub-picture, which is managed by frame line numbers, to field line numbers, and thus the scale of the circuit can be kept small.

Moreover, because the scan lines interpolated by the IP conversion portion 3 are decimated by the PI conversion portion 5, the interlaced video signal S1 that is input from the input terminal 1 and the interlaced video signal S6 that is output from the output terminal 7 are equivalent signals, and thus deterioration of picture quality due to the interlaced video signal S6 can be prevented. Also, as mentioned above, no time difference occurs between the progressive synthetic video signal S5 that is output from the output terminal 6 and the interlaced video signal S6 that is output from the output terminal 7.

Second Embodiment

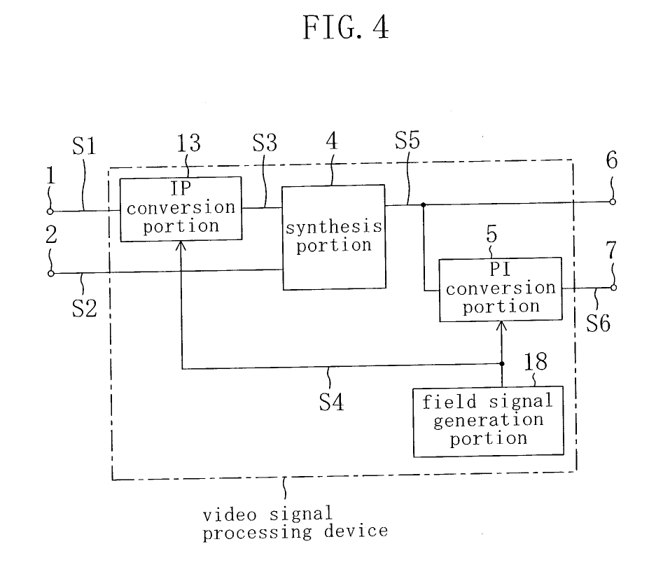

FIG. 4 is a diagram showing an example of the configuration of the video signal processing device according to a second embodiment of the invention.

The video signal processing device shown in FIG. 4 has an input terminal 1, an input terminal 2, an IP conversion portion 13 (corresponds to the IP conversion means), a synthesis portion 4 (corresponds to the synthesis means), a PI conversion portion 5 (corresponds to the PI conversion means), a field signal generation portion 18 (corresponds to the field signal generation means), an output terminal 6, and an output terminal 7.

The input terminal 1 is for input of an interlaced video signal S1 (corresponds to the first interlaced video signal).

The input terminal 2 is for input of a signal S2 (corresponds to the sub-video signal) displaying a sub-picture or an OSD.

The IP conversion portion 13 converts the interlaced video signal S1 from the input terminal 1 into a progressive video signal S3 (corresponds to the first progressive video signal) through scan line interpolation based on a later-described even/odd field identification signal S4 that is input from the field signal generation portion 18, and outputs this signal.

The synthesis portion 4 synthesizes the progressive video signal S3 that is output from the IP conversion portion 13 and the signal S2 displaying a sub-picture or an OSD from the terminal 2, and outputs a progressive synthetic video signal S5 (corresponds to the second progressive video signal).

The PI conversion portion 5 converts the progressive synthetic video signal S5 from the synthesis portion 4 into an interlaced video signal S6 (corresponds to the second interlaced video signal) based on the later-described even/odd field identification signal S4 that is input from the field signal generation portion 18.

The field signal generation portion 18 outputs the even/odd field identification signal S4 (corresponds to the field identification signal), which indicates whether the interlaced video signal S6 that is output from the PI conversion portion 5 is an odd-numbered field or an even-numbered field. The field signal generation portion 18 outputs an L-level even/odd field identification signal S4 in the case of an odd-numbered field, and outputs an H-level even/odd field identification signal S4 in the case of an even-numbered field.

The output terminal 6 outputs the progressive synthetic video signal S5 from the synthesis portion 4.

The output terminal 7 outputs the interlaced video signal S6 from the PI conversion portion 5.

Next, the operation of the video signal processing device according to this embodiment and configured as above is described.

The interlaced video signal S1 that is input from the input terminal 1 is converted into the progressive video signal S3 through scan line interpolation by the IP conversion portion 13 (described in detail later). Then, the synthesis portion 4 synthesizes the progressive video signal S3 and the signal S2 displaying a sub-picture or an OSD from the input terminal 2, and outputs the synthetic video signal S5. The synthetic video signal S5 from the synthesis portion 4 is output from the output terminal 6. Also, the progressive synthetic video signal S5 from the synthesis portion 4 is converted into the interlaced video signal S6 by the PI conversion portion 5 based on the even/odd field identification signal S4, and is output from the output terminal 7.

Next, the specific operation of the IP conversion portion 13 is described with reference to FIG. 2.

As shown in FIG. 2A, if the even/odd field identification signal S4 from the field signal generation portion 18 is L-level, then an odd-numbered field of the interlaced video signal S1 is input. In this case, the IP conversion portion 13 outputs the interlaced video signal S1 as odd-numbered scan lines of the progressive video signal S3. At this time, the IP conversion portion 13 outputs the interlaced video signal S1 as odd-numbered scan lines of the progressive video signal S3 at twice the speed at which the interlaced video signal S1 is input. Also, the even-numbered scan lines of the progressive video signal S3 are interpolated from the scan lines before and after the lines of the interlaced video signal S1 and are output.

On the other hand, as shown in FIG. 2B, if the even/odd field identification signal S4 from the field signal generation portion 18 is H-level, then an even-numbered field of the interlaced video signal S1 is input. In this case, the IP conversion portion 13 outputs the interlaced video signal S1 as even-numbered scan lines of the progressive video signal S3. At this time, the IP conversion portion 13 outputs the interlaced video signal S1 as even-numbered scan lines of the progressive video signal S3 at twice the speed at which the interlaced video signal S1 is input. Also, the odd-numbered scan lines of the progressive video signal S3 are interpolated from the scan lines before and after the lines of the interlaced video signal S1 and are output.

It should be noted that the method for scan line interpolation that has been described is a method of interpolation using the two lines before and after the scanned lines, however, there are no limitations to this.

Also, the operation of the PI conversion portion 5 is the same as described in the first embodiment, and thus description thereof is omitted.

As described above, with the video signal processing device according to the second embodiment of the invention, the even/odd field identification signal S4 is generated by the field signal generation portion 18, and thus the device of this embodiment differs from the device of the first embodiment only in that the means for generating the even/odd field identification signal S4 are different. Therefore, the device of this embodiment exhibits the same effects as the device of the first embodiment.

Third Embodiment

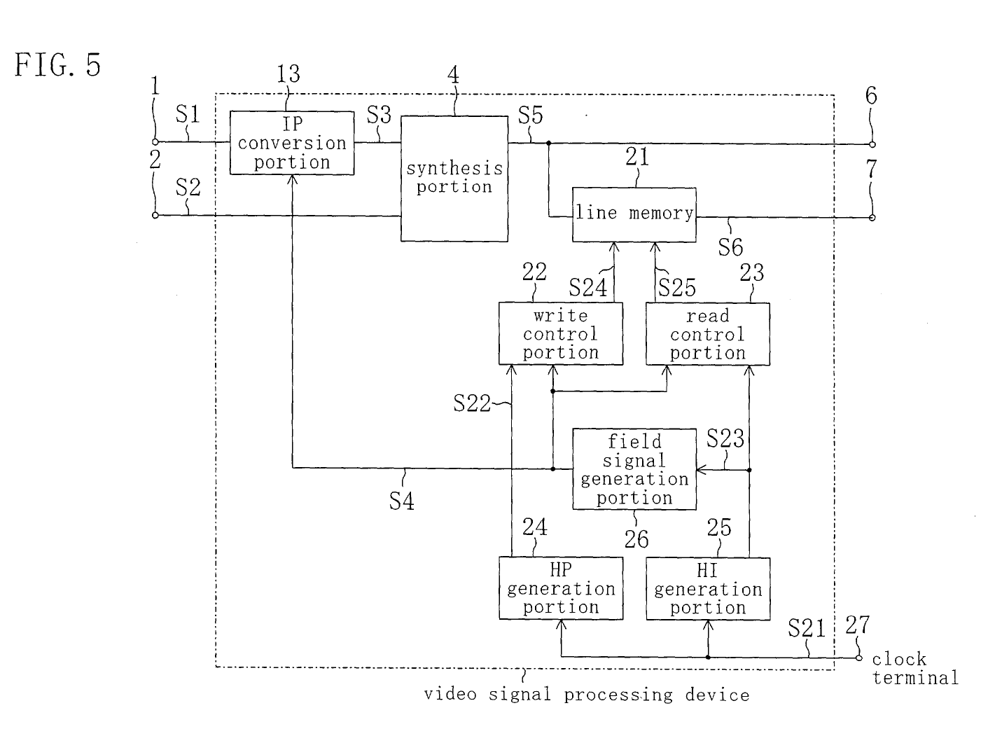

FIG. 5 is a diagram showing an example of the configuration of the video signal processing device according to the third embodiment of the invention.

The video signal processing device shown in FIG. 5 has an input terminal 1, an input terminal 2, an IP conversion portion 13 (corresponds to the IP conversion means), a synthesis portion 4 (corresponds to the synthesis means), a line memory 21, a write control portion 22 (corresponds to the write control means), a read control portion 23 (corresponds to the read control means), an HP generation portion 24 (corresponds to the progressive horizontal synchronizing pulse generation means), an HI generation portion 25 (corresponds to the interlaced horizontal synchronizing pulse generation means), a field signal generation portion 26 (corresponds to the field signal generation means), a clock input terminal 27, an output terminal 6, and an output terminal 7.

The HP generation portion 24 generates a progressive-type horizontal synchronizing pulse signal S22 (hereinafter referred to as “progressive horizontal synchronizing pulse signal”) from a clock signal S21 received from the clock input terminal 27, and outputs it.

The HP generation portion 25 generates an interlaced-type horizontal synchronizing pulse signal S23 (hereinafter referred to as “interlaced horizontal synchronizing pulse signal”) from the clock signal S21 received from the clock input terminal 27, and outputs it.

The field signal generation portion 26 outputs the even/odd field identification signal S4 (corresponds to the field identification signal), which indicates whether the interlaced video signal S6 that is output from the line memory 21 is an odd-numbered field or an even-numbered field, based on the interlaced horizontal synchronizing pulse signal S23 from the HI generation portion 25. The field signal generation portion 26 outputs an L-level even/odd field identification signal S4 in the case of an odd-numbered field and outputs an H-level even/odd field identification signal S4 in the case of an even-numbered field.

The write control portion 22 outputs a write control signal S24 to the line memory 21 based on the progressive horizontal synchronizing pulse signal S22 from the HP generation portion 24 and the even/odd field identification signal S4.

The read control portion 23 outputs a read control signal S25 to the line memory 21 based on the interlaced horizontal synchronizing pulse signal S23 from the HI generation portion 25 and the even/odd field identification signal S4.

It should be noted that here a description of structural elements that perform the same operation as the structural elements shown in FIG. 4 according to the second embodiment has been omitted.

First, the operation of the video signal processing device according to the third embodiment and configured as above is described briefly.

The interlaced video signal S1 (corresponds to the first interlaced video signal) that is input from the input terminal 1 is converted into the progressive video signal S3 (corresponds to the first progressive video signal) through scan line interpolation by the IP conversion portion 13. Then, the synthesis portion 4 synthesizes the progressive video signal S3 and the signal S2 displaying a sub-picture or an OSD from the input terminal 2, and outputs the synthetic video signal S5 (corresponds to the second progressive video signal). The synthetic video signal S5 from the synthesis portion 4 is output from the output terminal 6. Also, the progressive synthetic video signal S5 from the synthesis portion 4 is written into the line memory 21. The video signal that is read out from the line memory is output from the output terminal 7 as the interlaced video signal S6 (corresponds to the second interlaced video signal).

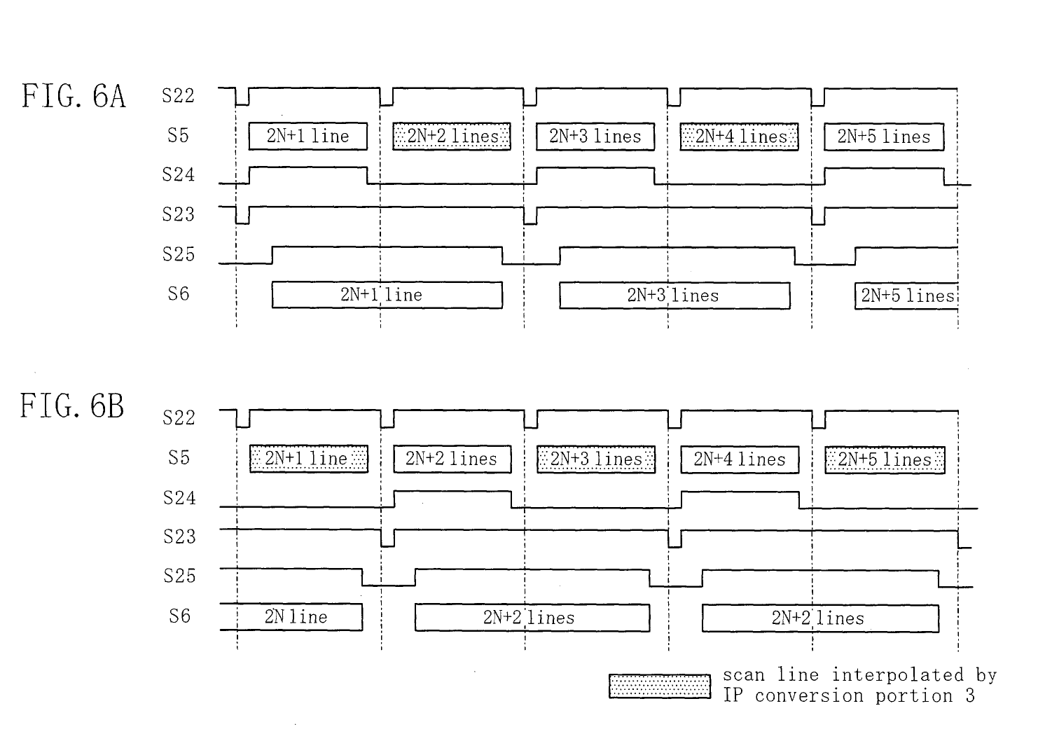

Next, the specific operations of the line memory 21, the write control portion 22, and the read control portion 23 are described with reference to FIG. 6.

FIG. 6 is a diagram for illustrating examples of conversion from the progressive synthetic video signal S5 to the interlaced video signal S6 using the line memory 21, the write control portion 22, and the read control portion 23.

FIG. 6A is a diagram for illustrating the operation when the even/odd field identification signal S4 is L-level, and FIG. 6B is a diagram for illustrating the operation when the even/odd field identification signal S4 is H-level. It should be noted that N in FIG. 6 is an integer.

The case shown in FIG. 6A, in which the even/odd field identification signal S4 is L-level, is described next. The write control signal S24 that is generated from the progressive horizontal synchronizing pulse signal S22 is H-level only when the progressive synthetic video signal S5 is an odd-numbered line, and during the period that the write control signal S24 is H-level the progressive video signal S5 is written into the line memory 21. Then, during the period that the read control signal S25 generated from the interlaced horizontal synchronizing pulse signal S23 is H-level, the interlaced video signal S6 is read out at half the speed of the synthetic video signal S5.

Next, the case shown in FIG. 6B, in which the even/odd field identification signal S4 is H-level, is described. The write control signal S24 that is generated from the progressive horizontal synchronizing pulse signal S22 is H-level only when the progressive synthetic video signal S5 is an even-numbered line, and during the period that the write control signal S24 is H-level the progressive video signal S5 is written into the line memory 21. Then, during the period that the read control signal S25 generated from the interlaced horizontal synchronizing pulse signal S23 is H-level, the interlaced video signal S6 is read out at half the speed of the synthetic video signal S5.

Thus, in accordance with whether the even/odd field identification signal S4 is L-level or H-level, by decimating either the even-numbered or the odd-numbered lines of the progressive synthetic video signal S5, the interlaced video signal S6 that is output from the line memory 21 becomes a signal equivalent to the interlaced video signal S1 that is input to the input terminal 1.

Also, because the line memory 21 outputs half the number of the scan lines of the input progressive synthetic video signal S5 at half the speed at which the progressive synthetic video signal S5 is input, no time difference occurs between the progressive synthetic video signal S5 that is input and the interlaced video signal S6 that is output. To put it differently, no time difference occurs between the progressive synthetic video signal S5 that is output from the output terminal 6 and the interlaced video signal S6 that is output from the output terminal 7.

As described above, the video signal processing device according to the third embodiment of the invention is capable of achieving the same effects as the devices of the first and the second embodiments.

As described above, with the present invention, the sub-picture or the OSD is synthesized after the interlaced video signal has been converted into a progressive video signal, and thus a blurred sub-picture or OSD image caused by scan line interpolation can be eliminated and the picture quality can be kept from deteriorating. Also, by decimating the scan lines that have been interpolated in the conversion from the interlaced video signal to a progressive video signal, a deteriorated picture quality due to the output of an interlaced video signal can be prevented.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A video signal processing device comprising:
an IP conversion means for converting a first interlaced video signal, which has been input, into a first progressive video signal and outputting it;
a synthesis means for synthesizing the first progressive video signal and a sub-video signal for displaying a sub-video that has been input, and outputting the result as a second progressive video signal; and
a PI conversion means for converting the second progressive video signal into a second interlaced video signal and outputting it;
wherein the second progressive video signal and the second interlaced video signal are both output.

2. The video signal processing device according to claim 1, wherein the sub-video signal that is synthesized by the synthesis means is a signal for displaying a sub-picture or an on-screen display.

3. The video signal processing device according to claim 1 or claim 2, wherein the IP conversion means interpolates scan lines from the first interlaced video signal so as to convert the first interlaced video signal into the first progressive video signal, and outputs the first progressive video signal, and
the PI conversion means decimates the scan lines that have been interpolated by the IP conversion means so as to convert the second progressive video signal into the second interlaced video signal, and outputs the second interlaced video signal.

4. The video signal processing device according to claim 3, wherein the IP conversion means
interpolates scan lines from the first interlaced video signal so as to convert the first interlaced video signal into the first progressive video signal, and outputs the first progressive video signal, and
outputs to the PI conversion means a field identification signal that indicates whether the first progressive video signal has been interpolated from scan lines of an odd-numbered field or an even-numbered field of the first interlaced video signal, and
the PI conversion means decimates even-numbered scan lines of the second progressive video signal and converts these to the second interlaced video signal if from the field identification signal it is determined that the first progressive video signal has been interpolated from scan lines of an odd-numbered field of the first interlaced video signal, and
decimates odd-numbered scan lines of the second progressive video signal and converts these to the second interlaced video signal if from the field identification signal it is determined that the first progressive video signal has been interpolated from scan lines of an even-numbered field of the first interlaced video signal.

5. A video signal processing device comprising:
an IP conversion means for converting a first interlaced video signal, which has been input, into a first progressive video signal and outputting it;
a synthesis means for synthesizing the first progressive video signal and a sub-video signal for displaying a sub-video that has been input and outputting the result as a second progressive video signal;
a PI conversion means for converting the second progressive video signal into a second interlaced video signal and outputting it; and
a field signal generation means for outputting a field identification signal that indicates whether a field of the second interlaced video signal from the PI conversion means is an odd-numbered field or an even-numbered field;
wherein the second progressive video signal and the second interlaced video signal are both output.

6. The video signal processing device according to claim 5, wherein the sub-video signal that is synthesized by the synthesis means is a signal for displaying a sub-picture or an on-screen display.

7. The video signal processing device according to claim 5 or claim 6, wherein the IP conversion means interpolates scan lines from the first interlaced video signal so as to convert the first interlaced video signal into the first progressive video signal and outputs the first progressive video signal, and
the PI conversion means decimates the scan lines that have been interpolated by the IP conversion means so as to convert the second progressive video signal into the second interlaced video signal and outputs the second interlaced video signal.

8. The video signal processing device according to claim 7, wherein the IP conversion means
in a case where the field identification signal received from the field signal generation means indicates an odd-numbered field, interpolates scan lines from an odd-numbered field of the first interlaced video signal so as to convert the first interlaced video signal into the first progressive video signal and outputs the first progressive video signal, and
in a case where the field identification signal received from the field signal generation means indicates an even-numbered field, interpolates scan lines from an even-numbered field of the first interlaced video signal so as to convert the first interlaced video signal into the first progressive video signal and outputs the first progressive video signal; and
wherein the PI conversion means decimates even-numbered scan lines of the second progressive video signal and converts these to the second interlaced video signal if the field identification signal received from the field signal generation means indicates an odd-numbered field, and
decimates odd-numbered scan lines of the second progressive video signal and converts these to the second interlaced video signal if the field identification signal received from the field signal generation means indicates an even-numbered field.

9. A video signal processing device comprising:
an IP conversion means for converting a first interlaced video signal, which has been input, into a first progressive video signal and outputting it;
a synthesis means for synthesizing the first progressive video signal and a sub-video signal for displaying a sub-video that has been input and outputting the result as a second progressive video signal;
a line memory for converting the second progressive video signal into the second interlaced video signal and outputting it;
a progressive horizontal synchronizing pulse generation means for outputting a progressive horizontal synchronizing pulse signal based on a clock signal that is input;
an interlaced horizontal synchronizing pulse generation means for outputting an interlaced horizontal synchronizing pulse signal based on the clock signal;
a field signal generation means for outputting a field identification signal that indicates whether a field of the second interlaced video signal from the line memory is an odd-numbered field or an even-numbered field, based on the interlaced horizontal synchronizing pulse signal from the interlaced horizontal synchronizing pulse generation means;
a write control means for outputting to the line memory a write control signal for controlling writing of the second progressive video signal to the line memory, based on the progressive horizontal synchronizing pulse signal from the progressive horizontal synchronizing pulse generation means and the field identification signal from the field signal generation means; and
a read control means for outputting to the line memory a read control signal for controlling reading of the second interlaced video signal from the line memory, based on the interlaced horizontal synchronizing pulse signal from the interlaced horizontal synchronizing pulse generation means and the field identification signal from the field signal generation means;
wherein the second progressive video signal that is output from the synthesis means and the second interlaced video signal that is read out from the line memory are both output.

10. The video signal processing device according to claim 9, wherein the sub-video signal that is synthesized by the synthesis means is a signal for displaying a sub-picture or an on-screen display.

11. The video signal processing device according to either claim 9 or claim 10, wherein the IP conversion means
in a case where the field identification signal received from the field signal generation means indicates an odd-numbered field, interpolates scan lines from an odd-numbered field of the first interlaced video signal so as to convert the first interlaced video signal into the first progressive video signal and outputs the first progressive video signal, and
in a case where the field identification signal received from the field signal generation means indicates an even-numbered field, interpolates scan lines from an even-numbered field of the first interlaced video signal so as to convert the first interlaced video signal into the first progressive video signal and outputs the first progressive video signal;
the write control means outputs the write control signal for writing the odd-numbered scan lines of the second progressive video signal to the line memory if the field identification signal from the field signal generation means indicates an odd-numbered field, and
outputs the write control signal for writing the even-numbered scan lines of the second progressive video signal to the line memory if the field identification signal from the field signal generation means indicates an even-numbered field; and
the read control means outputs the read control signal for reading, as the second interlaced video signal, scan lines of the second progressive video signal that have been written to the line memory according to the read control signal from the read control means.
